(19) United States
(12) Patent Application Publication
(10) Pub. No.: US 2008/0010534 A1
(43) Pub. Date: Jan. 10, 2008

(54) METHOD AND APPARATUS FOR ENHANCING GRAPHICAL USER INTERFACE APPLICATIONS

(75) Inventors: Anant Athale, Schaumburg, IL (US); Thomas M. Tirpak, Glenview, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/382,132

(22) Filed: May 8, 2006

(51) Int. Cl. G06F 11/00

(52) U.S. Cl. 714/38

(57) ABSTRACT

A system and method (500) are disclosed for a method and apparatus for manipulating GUIs. A system that incorporates teachings of the present disclosure may include, for example, a computing device (100) having a controller (108) that manages a display (110). The controller can be programmed to alter (518) a graphical user interface (GUI) (200-400) presented on the display according to a behavior model that predicts (508-510) an expectation of an end user from observations of the end user's interactions with the GUI. Additional embodiments are disclosed.

### FIELD OF THE DISCLOSURE

The present disclosure relates generally to graphical user interfaces (GUIs), and more specifically to a method and apparatus for enhancing GUI applications.

### BACKGROUND

Software developers typically use software development kits to tailor a GUI application according to the context of a transaction. For example, in the case of an Internet browser its GUI is tailored for browsing content on remote servers. A file system browser has a GUI tailored for file system management. A text editor GUI is tailored for editing text, importing tables, images, and so on.

Although the foregoing GUI applications have been effective in assisting end users on a number of tasks, such applications are not generally adapted to learn and improve themselves. Furthermore, current techniques for implementing GUI applications require hard-coding of adaptable features and adaptation mechanisms thereof

A need therefore arises for a method and apparatus that enhances GUI applications.

### BRIEF DESCRIPTION OF THE DRAWINGS

FIG. 1 depicts an exemplary block diagram of a computing device (CD);

FIGS. 2-4 depict exemplary graphical user interface (GUI) applications;

FIG. 5 depicts an exemplary flowchart of a method operating in the CD; and

FIG. 6 is a diagrammatic representation of a machine in the form of a computer system within which a set of instructions, when executed, may cause the machine to perform any one or more of the methodologies discussed herein. Each figure is in accordance with certain, but necessarily the same, embodiments of the invention.

### DETAILED DESCRIPTION

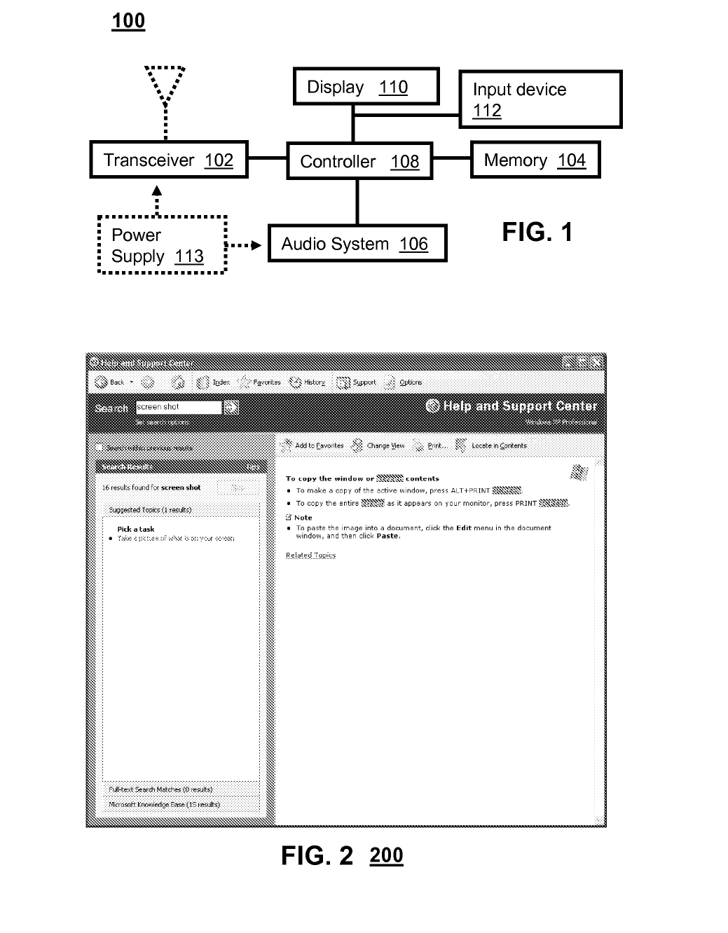

FIG. 1 is an exemplary block diagram of a computing device (CD) 100, in accordance with certain embodiments of the invention. The CD 100 can utilize a common wired transceiver 102 coupled to one of a number of wired interface technologies such as for example POTS, DSL, or cable. Alternatively, or in combination the CD 100 can include short range wireless communications technology in the transceiver 102 such as used by cordless phones, Bluetooth or WiFi devices to support mobility within a small area such as in a residence or commercial enterprise.

The transceiver 102 can be further supplemented with technology that supports mid to long-range wireless communications such as cellular, WiMAX, or SDR technologies. The CD 100 can also operate as a multimode device. That is, when the CD 100 is within a building it can perform communication activities over a wired DSL interface, a POTS interface, a WiFi, or a Bluetooth™ interface, and so on. In this setting, these interfaces can support data communications, Voice over IP (VoIP) communications by way of an IP network, and POTS voice messaging. When roaming outside the building, the CD 100 can exchange data and voice messages over a cellular network or other long-range networks such as WiMAX.

Each of the foregoing embodiments for the CDs 116 can utilize a memory 104, an audio system 106, and a controller 108 among other possible components. The memory 104 can comprise storage devices such as RAM, SRAM, DRAM, and/or Flash memories. The memory 104 can be external or an integral component of the controller 108. The audio system 106 can be utilized for exchanging audible signals with an end user. The CD 100 can further include a display 110 for conveying images to the end user, an input device 112 (such as a keypad and mouse) for manipulating operations of the CD 100, and a portable power supply 113. The audio system 106, the display 110, and the input device 112 can singly or in combination represent a user interface (UI) for controlling operations of the CD 100 as directed by the end user. The controller 108 can manage the foregoing components by utilizing common computing technology such as a microprocessor and/or digital signal processor.

In a distributed processing environment, the controller 108 can represent a plurality of processors. In this embodiment a computing device may be described as a laptop computer comprising a first processor interacting with server comprising a second processor, each performing a variety of tasks that collectively produce the functions of the computing device. Accordingly, the present disclosure can be applied to a single processing unit operating in a centralized computing environment, or a plurality of processing units in a decentralized computing environment which singly or in combination represent a computing device.

From the foregoing descriptions of the CD 100, it would be evident to an artisan with ordinary skill in the art that the CD 100 can be embodied in a desktop computer, a laptop computer, a personal digital assistant (PDA), a server, or a cell phone among other devices. Any embodiment of the CD 100 in which a graphical user interface (GUI) is employed can be applied to the present disclosure.

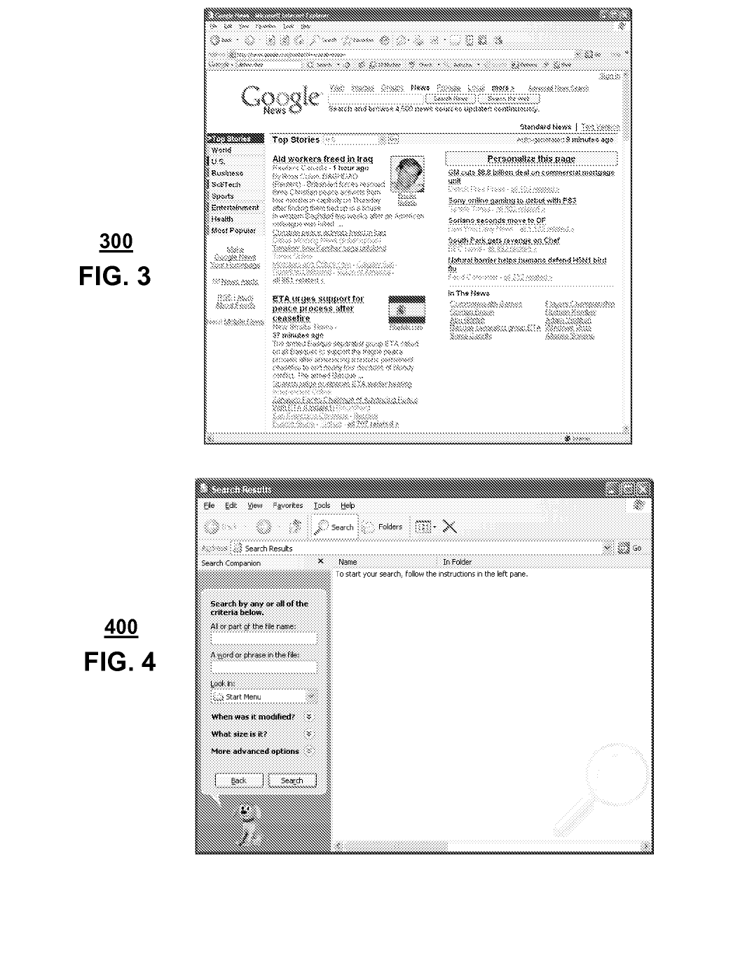

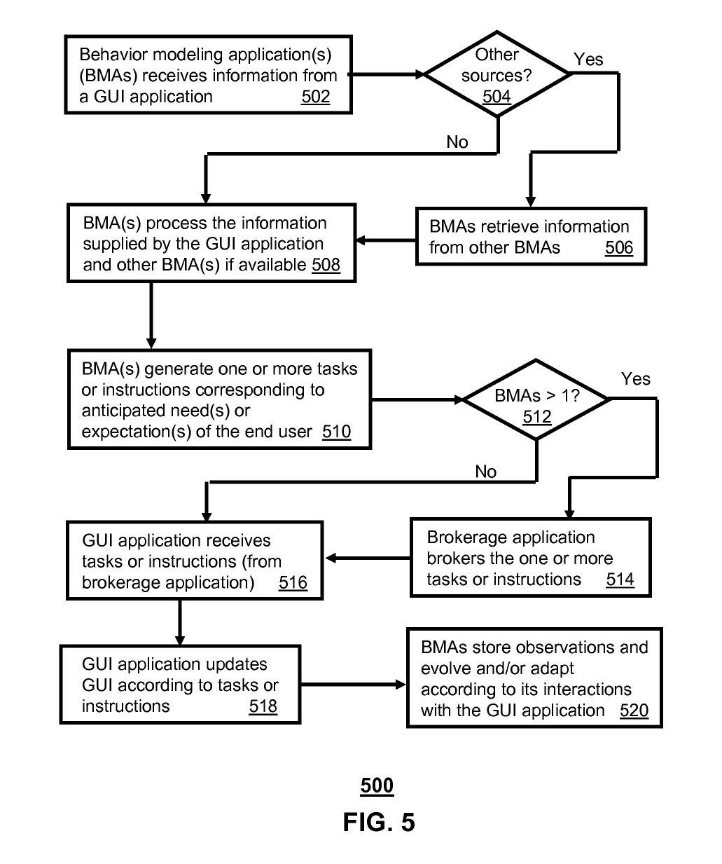

FIGS. 2-4 depict exemplary GUI applications 200-400 that can be manipulated by the controller 108 of the CD 100 according to a method 500 operating in the CD 100 as depicted in the flowchart of FIG. 5, in accordance with certain embodiments of the invention. There are many other GUI applications that can be applied to method 500 that are not depicted in FIGS. 2-4. Accordingly, the GUI applications 200-400 are presented for illustration purposes only and should not be considered limiting to the present disclosure. The GUIs illustrated in FIGS. 2 and 4 are copyrighted by Microsoft, Inc. The GUI illustrated in FIG. 3 is copyrighted by Google.

With this in mind, method 500 begins with step 502 in which one or more behavior modeling applications (BMAs) receive information from a GUI application. In the present context, a BMA can represent a mechanism for predicting a behavior of an end user based on temporal and/or task-context observations of the end user. From one perspective, an implementation of a BMA represents an input-output mapping between the system state, as represented by the information collected from one or more GUI applications, and the selection of a set of adaptations to a specific GUI application which are likely to be beneficial to the end user.

BMAs can be synthesized, represented, and updated by means of behavioral modeling methods, including without limitation a linear regression model, rule-based expert system, a neural network model, or a genetic programming model (such as described in Evolving Accurate and Compact Classification Rules with Gene Expression Programming, published in IEEE Transactions on Evolutionary Computation, Vol. 7, No. 6, pages 519-531). Genetic Programming is the superset of Machine Learning techniques that includes Gene Expression Programming. Methods for automatically synthesizing a model, such as the aforementioned, are well known in the art and can be implemented in software, hardware or combinations thereof. These methods can also be adapted to utilize persistence principles on observable data associated with the end user. Persistence of data includes, but is not limited to the existence of historical information about the end user's interactions with a GUI and the persistence of synthesized models.

The GUI application can be any software application that utilizes a GUI interface for interacting with end users. FIG. 2 shows for example a help GUI application from Microsoft for assisting end users with questions they may have with the operations of the Windows operating system or Office applications. Similarly, FIGS. 3-4 show GUI applications of Microsoft's Internet Explorer and File system Search Window. Each of these applications interacts with end users by way of keyboard entries, mouse selections, and/or voice recognition.

An application programming interface (API) can be defined for each of the BMA and the GUI applications to ease the transfer of information between these components. The information supplied by the GUI application to the BMA over the API can include without limitation an identification of the GUI application (e.g., Internet Explorer, Mozzilla, Word, Excel, Access, etc.), a description of the GUI application's resources for manipulating images (e.g., text manipulation resources, graphics manipulation resources, display resolution capabilities, color metrics, and so on), a description of operating system resources utilized by the GUI application (e.g., active communication links, UI toolkit resources being used, etc.), and a description of the interactions taking place between the GUI application and the end user (e.g., hyperlink selected by end user, web addressed being viewed, search terms entered by end user, etc.).

In step 504, the BMA can be programmed to search for other sources of information. In an operating environment with multiple BMAs, the BMAs can be designed to collaborate in step 506 with each other and share their learning experiences from end user interactions with other GUI applications. For example, a first BMA that previously interacted with an Internet browser GUI application can share its knowledge with a second BMA that is presently interacting with a file system GUI application. The information shared can include a history of predictions made by the first BMA along with corresponding temporal and task information. Temporal information can include for example a timestamp associated with each interaction with the GUI application. Task information can include behavior data corresponding to the end user's interactions with the GUI application for each instance of use. The requesting BMA can use or discard the information collaborated by the other BMAs to improve its performance to predict end user behavior.

In one embodiment, more than one BMA can be sought out by a GUI application to provide it selectable options in predicting the end user's anticipated need. In such circumstances, each BMA in step 508 can be programmed to process the aforementioned information from the GUI application and from other BMAs, thereby generating in step 510 one or more tasks or instructions corresponding to a plurality of anticipated needs or expectations predicted by the BMAs. If more than one BMA is detected in step 512 to be attempting to supply the GUI application said instructions or tasks, the controller 108 can be programmed to call on a brokerage application in step 514 to resolve conflicts.

The brokerage application can be a software or hardware application or combinations thereof that brokers between multiple BMA sources so that the GUI application is not confused or given conflicting directions. The brokerage application can conform to common brokering or arbitrating techniques known in the art. For example, each BMA can provide a confidence level for each of its predictions. The prediction having the highest confidence level can be selected by the brokerage application. Alternatively, the brokerage application can detect that the predictions provided by the BMAs are complimentary so that allowing multiple BMAs to direct the GUI application would be feasible.

In other embodiments, the brokerage application can track a history of predictions generated by the BMAs and determine the success rate of said predictions by observing the end user reaction to the directions given by the BMAs. For instance if the end user responds to a GUI update by performing a complementary action, then the brokerage application can assume the BMA's prediction was successful. Contrary responses can be recorded as a rejection. The history of acceptances and rejections tracked for each BMA can be used by the brokerage application as a means to select BMA directions under conflicting circumstances.

It should be evident from these examples that there can be endless possibilities on how a brokerage application might be designed. For practical reasons, these other embodiments have not been presented in this disclosure.

Referring back to FIG. 5, the GUI application can be programmed in step 516 to receive the tasks and/or instructions from a single BMA, or the synthesized tasks and/or instructions from the brokerage application from step 514. With this information, the GUI application in step 518 updates the GUI accordingly.

Any task or instruction can be supplied to the GUI application for revising a presentation conveyed by the GUI. For example, in the case of a search GUI application such as in FIG. 4, said application can be directed by the BMA to search in a particular area of a file system first to speed the search process. The GUI in this instance presents the targeted area in the file system first before other search results are presented. In the same example, the BMA can direct the GUI application to invoke an application for a selected file (e.g., opening a Word document without the end user's interaction) thereby saving the end user the step of making the selection. Moreover, the BMA can submit comments, suggestions, or inquiries to the end user that appear in the window as balloon statements similar to those used by Microsoft Word's Office Assistant.

Another exemplary embodiment is a simple time based BMA and an associated navigation application. A next generation document navigator similar to the Windows Explorer (an application distributed by Microsoft in its operating systems) may be able to be made “smarter” such that the next generation document navigator can intelligently predict a folder or document that is “most likely of interest” in a displayed list that a user might want to open. One example of the operation of a BMA for this exemplary embodiment follows (the BMA is named “AIM” in this listing):

```
<?xml version=“1.0” encoding=“UTF-8”?>
<iam>
<title>Smart Navigator</title>
<description>IAM model for Navigator Adaptation</description>
<id>001</id>
    <element>
        <name>List</name>
        <model>
            <default-order weight=“1”>alpha</default-
order>
            <usage-count weight=“”/>
            <average-use-frequency weight=“”/>
            <average-use-duration weight=“”/>
        <custom-attribute>....</custom-attribute>
            <custom-attribute>....</custom-attribute>
            <custom-attribute>....</custom-attribute>
            <history>
                <time-of-use weight=“”>
                    <start-time></start-time>
                    <end-time></end-time>
                </time-of-use>
            </history>
            <adaptation>sort</adaptation>
        </model>
    </element>
    <element>....</element>
    <element>....</element>
    <element>....</element>
</iam>
```

It should be noted that the above listing describes a BMA that uses temporal interaction variables, in this example “average-use-frequency”, “average-use-duration”, as an input from the GUI and provides adaptation parameters, in this example “adaptation”, as the output for the GUI. The BMA may be used by a GUI element, in this example “List”, that uses temporal interaction variables such as those described above, through a handler, in this example a list handler, that uses adaptation parameters such as those described above. The handler may be either hard coded as part of the GUI or be supported by using GUI elements that are naturally “BMA-aware”. The listing above should not be interpreted as specific “hard” coding since the BMA may be implemented by a variety of techniques as described elsewhere herein (e.g., neural network). Furthermore, the BMA may be able to interact with a wide class of other GUIs having other types of handlers that use temporal or task interaction “input” variables and adaptation “output” parameters not included in this operational example. Utilizing the BMA model, the navigator application can adapt to simplify the user interaction by making the prediction. The BMA could be adapted to modify the GUI by, for example, providing values for adaptation parameters that cause a sorting by the GUI of the displayed list according to a probability of interest derived based on temporal usage pattern, as provided for in the above draft code listing. In an alternative example, the GUI or another GUI may have a list handler that uniquely identifies documents or folders of higher probabilities of interest using some visual indication such as color or an arrow, etc. (instead of by sorting), by using other adaptation parameters. The same BMA could be used to modify these adaptation parameter values through a similar learning process exemplified by the above listing.

The directions supplied by the BMAs to the GUI applications can be as sophisticated as the resources made available by the GUI application. Accordingly, directions may be provided by the BMAs at various levels of detail depending on the controllable aspects of the GUI applications. Accordingly, the BMAs can be programmed to manage GUI pixels and/or operations of the GUI such as operating system resource calls, manage content presented in the window, manage search patterns, and so on.

The BMA and the GUI applications can be architected in many ways. For example the BMA and GUI applications can be integrated into a single application in which case each GUI application has its own BMA. This embodiment can be useful in real-time applications where speed is essential. Alternatively, the BMA and GUI application can be decentralized. A BMA can be assigned to a single GUI application or it can be assigned to many GUI applications. In either case, the decentralization of the BMA and GUI applications provides a simpler means to upgrade and maintain the BMA and the GUI applications. Additionally, a pool of BMAs can be programmed to serve a pool of GUI applications. Additionally, the GUI applications can be programmed to selectively request for specific BMAs.

It should be evident to an artisan with ordinary skill in the art that there are innumerable embodiments of the BMAs and GUI applications not disclosed herein. Additionally, it would be apparent to said artisan that the embodiments disclosed can be rearranged, modified, reduced, or enhanced without departing from the scope and spirit of the claims described below. The reader is therefore directed to the claims for a fuller understanding of the breadth and scope of the present disclosure.

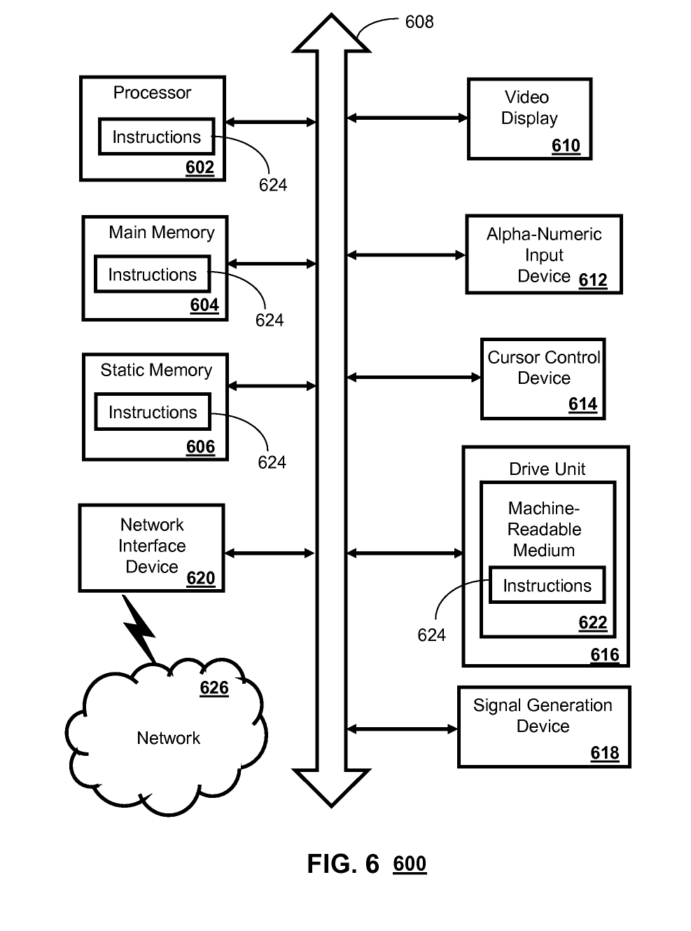

FIG. 6 is a diagrammatic representation of a machine in the form of a computer system 600 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU, or both), a main memory 604 and a static memory 606, which communicate with each other via a bus 608. The computer system 600 may further include a video display unit 610 (e.g., a liquid crystal display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control) and a network interface device 620.

The disk drive unit 616 may include a machine-readable medium 622 on which is stored one or more sets of instructions (e.g., software 624) embodying any one or more of the methodologies or functions described herein, including those methods illustrated above. The instructions 624 may also reside, completely or at least partially, within the main memory 604, the static memory 606, and/or within the processor 602 during execution thereof by the computer system 600. The main memory 604 and the processor 602 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium, comprising computer instructions for:
processing according to a behavior model information associated with a graphical user interface (GUI) affected by interactions with an end user; and
revising the GUI according to an anticipated need of the end user as predicted by the behavior model.

2. The storage medium of claim 1, comprising computer instructions corresponding to the behavior model for processing a neural network that predicts the anticipated need of the end user.

3. The storage medium of claim 1, comprising computer instructions corresponding to the behavior model for performing a linear regression on prior observations of the end user's behavior, thereby predicting the anticipated need of the end user.

4. The storage medium of claim 1, comprising computer instructions corresponding to the behavior model for processing a genetic programming model that predicts the anticipated need of the end user.

5. The storage medium of claim 1, comprising a behavior modeling application corresponding to the behavior model and a GUI application that manages operations of the GUI, wherein the behavior modeling application and the GUI application conform to an application programming interface (API) for exchanging messages.

6. The storage medium of claim 5, wherein the information associated with the GUI comprises at least one among an identification of the GUI application, a description of the GUI application's resources for manipulating images, a description of operating system resources utilized by the GUI application, and a description of the interactions taking place between the GUI application and the end user.

7. The storage medium of claim 1, comprising computer instructions for:
generating one or more tasks corresponding to the anticipated need of the end user; and
revising an image associated with the GUI according to the one or more tasks.

8. The storage medium of claim 5, wherein the behavior modeling application comprises computer instructions for:
recalling the end user's interactions with the GUI application; and
predicting the anticipated need of the end user according to the recalled interactions.

9. The storage medium of claim 5, wherein the behavior modeling application comprises computer instructions that evolve from interactions with the GUI application.

10. The storage medium of claim 1, comprising computer instructions corresponding to the behavior model for processing the information associated with the GUI according to at least one among a temporal model of the end user's behavior and a task-context model of the end user's behavior.

11. The storage medium of claim 5, wherein the behavior modeling application comprises computer instructions for processing additional information supplied thereto by other GUI applications to predict the anticipated need of the end user.

12. A computer-readable storage medium in a computing device, comprising computer instructions for:
processing according to a plurality of behavior models information associated with a graphical user interface (GUI) affected by interactions with an end user; and
updating the GUI according to at least one among a plurality of anticipated needs of the end user predicted by the corresponding plurality of behavior models.

13. The storage medium of claim 12, comprising a plurality of behavior modeling applications corresponding to the plurality of behavior models and a GUI application that manages operations of the GUI, wherein the behavior modeling applications and the GUI application conform to an application programming interface (API) for exchanging messages.

14. The storage medium of claim 13, comprising computer instructions in the GUI application for:
selecting one or more of the anticipated needs predicted by the behavior models; and
manipulating a presentation delivered to the end user by way of the GUI according to the one or more anticipated needs selected.

15. The storage medium of claim 13, comprising a brokerage application, wherein the brokerage application comprises computer instructions for brokering one or more instructions directed to the GUI application by the behavior modeling applications for updating the GUI.

16. The storage medium of claim 13, wherein the behavior modeling applications comprise computer instructions for sharing information therebetween to predict the anticipated needs of the end user.

17. The storage medium of claim 13, wherein the behavior modeling applications comprise computer instructions for processing information supplied thereto by other GUI applications to predict the anticipated needs of the end user.

18. The storage medium of claim 12, wherein the plurality of behavior models comprise at least one among a neural network application, a rule-based expert system application, a linear regression application, and a genetic programming application.

19. The storage medium of claim 13, wherein the information associated with the GUI comprises at least one among an identification of the GUI application, a description of the GUI application's resources for manipulating images, a description of operating system resources utilized by the GUI application, and a description of the interactions taking place between the GUI application and the end user.

20. A computing device, comprising a controller that manages a display, wherein the controller is programmed to alter a graphical user interface (GUI) presented on the display according to a behavior model that predicts an expectation of an end user from observations of the end user's interactions with the GUI.
